(19) United States
(12) Patent Application Publication
(10) Pub. No.: US 2009/0059979 A1
(43) Pub. Date: Mar. 5, 2009

(54) OPTICAL TRANSMISSION MODULE AND OPTICAL TRANSMISSION SYSTEM

(76) Inventor: HIROMASA TANAKA, Tokyo (JP)

Correspondence Address: NEC CORPORATION OF AMERICA, 6535 N. STATE HWY 161, IRVING, TX, 75039, US

(21) Appl. No.: 12/203,304

(22) Filed: Sep. 3, 2008

(30) Foreign Application Priority Data
Sep. 4, 2007 (JP) 2007-229283

(51) Int. Cl. H01S 3/04

(52) U.S. Cl. 372/36; 372/34

(57) ABSTRACT

The present invention provides an optical transmission module and an optical transmission system including a plurality of components including a light-emitting device mounted on a holding unit, capable of restraining a distortion caused by a temperature difference between top and bottom faces of a temperature adjusting unit that performs temperature adjusting for the light-emitting device, the holding unit and the like and capable of maintaining stable optical performance. For such exemplary object, an optical transmission module includes: a holding unit, on which a plurality of components including at least a light-emitting device is mounted; a temperature adjusting unit for adjusting temperature of at least the holding unit and the light-emitting device; and a heating unit provided inside the holding unit.

### INCORPORATION BY REFERENCE

This application is based upon and claims the benefit of priority from Japanese patent application No. 2007-229283, filed on Sep. 4, 2007, the disclosure of which is incorporated herein in its entirety by reference.

### BACKGROUND OF THE INVENTION

1. Field of the Invention

The present invention relates to an optical transmission module and an optical transmission system, which output an optical beam, for example, with a semiconductor laser device.

2. Description of Related Art

As an optical transmission module relating to the present invention, there is an optical transmission module including a laser device 101, a monitor PD (Photodiode) 102, a thermistor 103 and a lens 104 which are mounted on a carrier 106, as illustrated in FIG. 1. The carrier 106 is mounted on a Peltier device 107.

In order to keep an oscillation wavelength constant and stabilize a light output, the laser device 101 has to be controlled to keep the temperature constant. Accordingly, in the optical transmission module illustrated in FIG. 1, for temperature control, the thermistor 103 is mounted in the vicinity of the laser device 101 and electric current is passed through the Peltier device 107 to keep the resistance value of the thermistor 103 constant.

In addition, as an optical transmission system relating to the present invention, there is an optical transmission system including a semiconductor laser device, an electroabsorption type semiconductor optical modulator device and a temperature control unit capable of independently controlling temperatures of these devices. As the temperature control unit, there is a unit in which a resistive element is vapor-deposited on a bottom portion of each of the semiconductor laser device and the electroabsorption type semiconductor optical modulator device to provide an electric heater and a thermoelectric cooling element is further mounted thereunder, for example, as disclosed in Japanese Patent Application Laid-Open No. 2000-228556.

As an optical device module relating to the present invention, there is a module in which an integrated heat transfer module including a heat source and a temperature sensor is mounted on a photonic device, for example, as disclosed in Patent Application laid-Open No. 2002-232065.

As another system relating to the present invention, there is a system in which semiconductor laser is provided in a case which shields a laser beam exit end face from the outside air and drives a heater based on a signal detected by an outside air temperature detector, for example, as disclosed in Patent Application Laid-Open No. 61-216381.

Next, problems of the respective conventional techniques will be described below.

In the case of the optical transmission module illustrated in FIG. 1, if a temperature difference between a package 108 and the carrier 106 is attempted to increase when, for example, a temperature of outside of the package lowers, a temperature difference between top and bottom faces of the Peltier device 107 becomes larger and hence a distortion may occur at the Peltier device. The distortion thus generated at the Peltier device influences a mounting state of a laser device or a lens. As a result, laser beam deviates and light output declines.

In the technique described in Patent Application Laid-Open No. 2000-228556, an electric motor is provided on a thermoelectric cooling element and therefore a large temperature difference may occur between top and bottom faces of the thermoelectric cooling element, however measures against the distortion caused by a temperature difference between the top and bottom faces of the thermoelectric cooling element is not considered. The technique is related to a structure with individual components fixed on a case through the thermoelectric cooling element, so stable fixing by mounting a plurality of components including a light-emitting device on a holding unit, such as a substrate, is not considered in the technique.

The module according to the Patent Application Laid-Open No. 2002-232065 includes a heater serving a heat source as an integrated heat transfer module and does not include consideration of a temperature adjusting unit including a cooling function. The module is structured so that one photonic device is mounted on an integrated heat transfer module and does not include consideration of stable fixing of individual components by mounting a plurality of components including a light-emitting device on a holding unit such as a substrate.

The system according to the Patent Application Laid-Open No. 61-216381 includes a heater driven based on a signal detected by an outside air temperature detector and does not include consideration of a temperature adjusting unit including a cooling function. The system is provided with a semiconductor laser mounted on a case and does not include consideration of stable fixing of individual components by mounting a plurality of components including a light-emitting device on a holding unit such as substrate.

### SUMMARY

The exemplary object of the present invention aims to solve the respective problems described above. Accordingly, it is an exemplary object of the present invention to provide an optical transmission module and an optical transmission system including a plurality of components including a light-emitting device mounted on a holding unit, capable of restraining a distortion caused by a temperature difference between top and bottom faces of a temperature adjusting unit that performs temperature adjustment for the light-emitting device, the holding unit and the like and capable of maintaining stable optical performance.

To achieve the exemplary object, according to the present invention, an optical transmission module is an optical transmission module including: a holding unit, on which a plurality of components including at least a light-emitting device are mounted; a temperature adjusting unit that performs temperature adjustment of the holding unit and the light-emitting device; and a heating unit provided inside the holding unit.

An optical transmission system according to the present invention includes an optical transmission module according to the above invention.

### BRIEF DESCRIPTION OF THE DRAWINGS

FIG. 1 is a longitudinal sectional view illustrating an optical transmission module as a related art of the present invention;

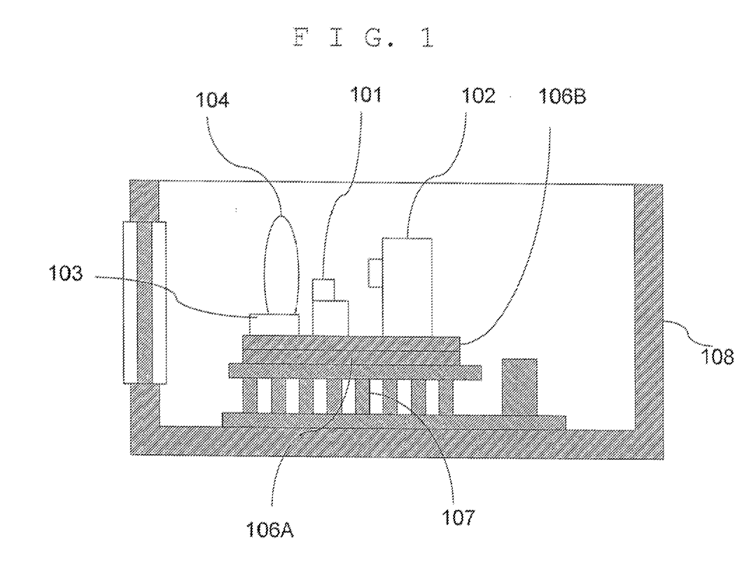

FIG. 2 is a schematic view of a substantial part of an optical transmission module in respective exemplary embodiments of the present invention;

FIG. 3 is a top view illustrating a structure of an optical transmission module in accordance with a first exemplary embodiment of the present invention;

FIG. 4 is a sectional view taken along line A-A′ of FIG. 3;

FIG. 5 is a block diagram illustrating a control configuration around the optical transmission module;

FIG. 6 is a top view illustrating a structure of an optical transmission module in accordance with a second exemplary embodiment of the present invention;

FIG. 7 is a longitudinal sectional view illustrating a detailed structure of an optical transmission module and around a carrier thereof in accordance with a third exemplary embodiment of the present invention;

FIG. 8 is a longitudinal sectional view illustrating a detailed structure of an optical transmission module and around a carrier thereof in accordance with a fourth exemplary embodiment of the present invention; and

FIG. 9 is a longitudinal sectional view illustrating a detailed structure of an optical transmission module and around a carrier thereof in accordance with a fifth exemplary embodiment of the present invention.

### Exemplary Embodiment

Referring next to the accompanying drawings, detailed description will be made on an exemplary embodiment as an application of an optical transmission module and an optical transmission system according to the present invention.

First, an outline common to each exemplary embodiment will be described below.

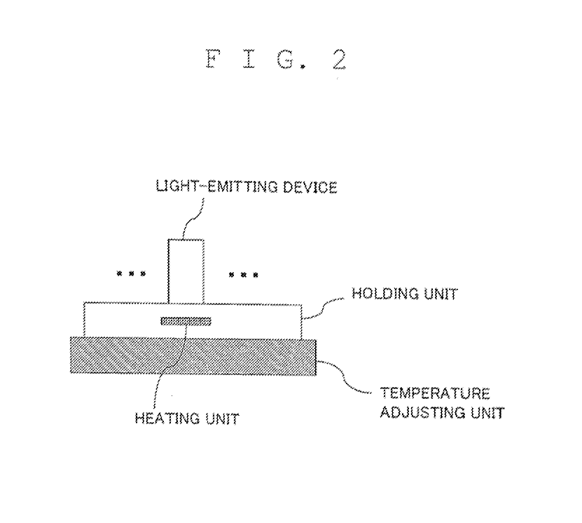

An optical transmission module in each exemplary embodiment of the present invention is structured, as illustrated in FIG. 2, so that a plurality of components including at least a light-emitting device is mounted on one surface of a holding unit and a temperature adjusting unit which performs temperature adjustment of the holding unit and the light-emitting device is fixed on the other surface. In addition, a heating unit for heating the light-emitting device is provided inside the holding unit.

In each exemplary embodiment of the present invention, the heating unit provided inside the holding unit in this way performs temperature control for a laser device together with the temperature adjusting unit under the holding unit. Thus, in increasing the temperature around the light-emitting device, a temperature difference between top and bottom faces of the temperature adjusting unit can be prevented from increasing. Accordingly, generation of distortion caused by a temperature difference between top and bottom faces of the temperature adjusting unit is restrained, thus maintaining stable optical performance without laser beam being deviated.

### First Exemplary Embodiment

Referring next to the accompanying drawings, detailed description will be made on a first exemplary embodiment of the present invention.

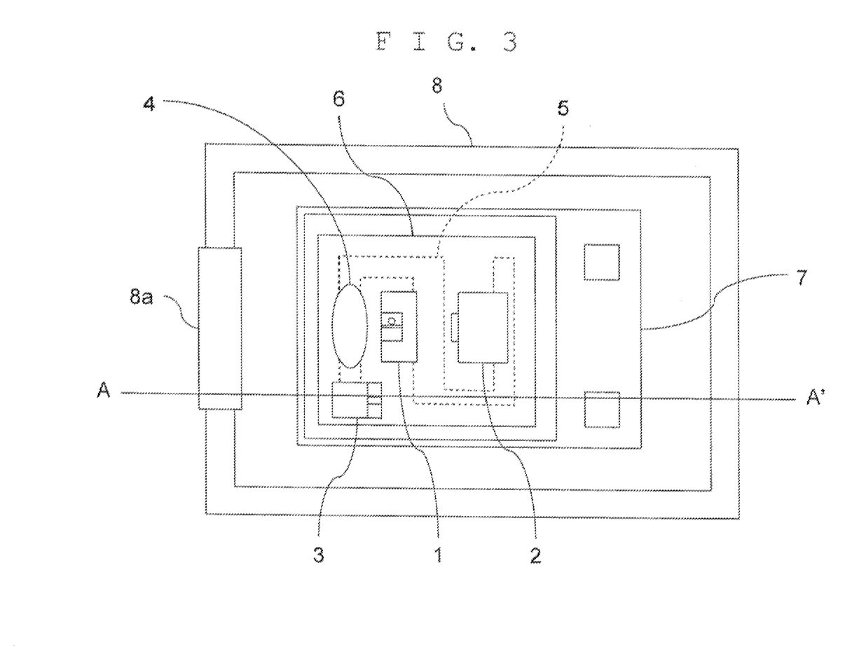

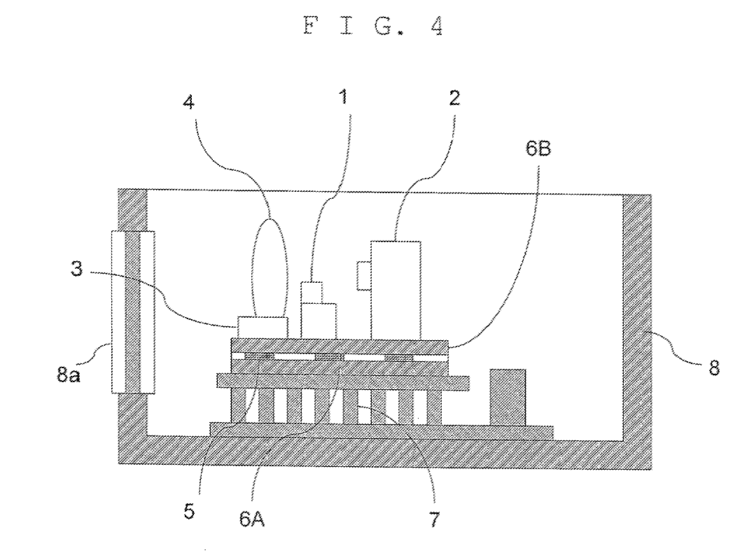

FIG. 3 illustrates a top view of an optical transmission module in accordance with a first exemplary embodiment of the present invention. FIG. 4 illustrates a sectional view taken along line A-A′ of FIG. 3.

As illustrated in FIGS. 3 and 4, a laser device (a light-emitting device) 1 generating laser beam, a monitor PD (Photodiode) 2 for monitoring a light output by the laser device 1, a thermistor (a light-emitting device temperature sensing unit) 3 for monitoring the temperature of the laser device 1, and a lens (an optical component) 4 for focusing laser beam are mounted on a carrier (a holding unit) 6 formed as a multilayer board of ceramic substrates (plate-shaped members) 6A and 6B.

The carrier 6 is firmly secured on a Peltier device (a temperature adjusting unit) 7. Further, the Peltier device 7 is firmly secured in a package 8 made of a metallic material such as KOVAR. A transmissive window 8a is formed on the package 8 for outputting laser beam condensed from the laser device 1 through the lens 4.

The carrier 6 includes the ceramic substrates 6A and 6B and is structured as a multilayer substrate provided with a wiring pattern and the like. Between the ceramic substrates 6A and 6B, a heater (a heating unit) 5, which is a resistive element formed of alloy thin-film including platinum. In place of the ceramic substrates 6A, 6B, aluminum nitride or silicon substrate may be used.

To the heater 5, electric current is supplied from the outside of the package 8 through wire bonding or wiring. At this time, in the heater 5, Joule heat is generated depending upon an electric current 5 amount being supplied and a resistance value of the heater 5 itself. This heat raises the temperature of the laser device 1 and the thermistor 3 or the like through a ceramic substrate 6B. Accordingly, controlling the current passing through the heater 5 provides an effect that the temperature of the laser device 1 provided right above or around the heater 5 can be variably controlled.

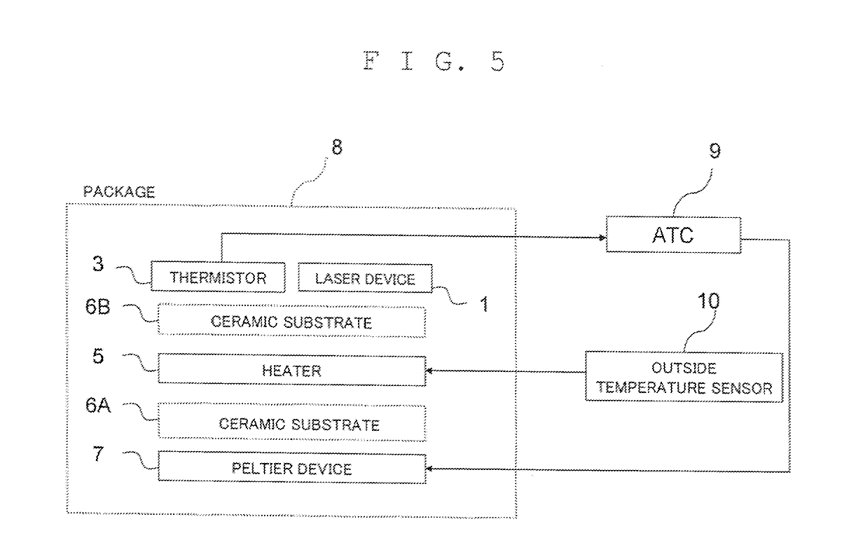

Next, referring to a functional block diagram in FIG. 5, description will be made on the temperature control operation in the optical transmission system including the optical transmission module according to the exemplary embodiment.

The laser device 1 has to keep an oscillation wavelength constant. Accordingly, the temperature of the laser device 1 has to be adjusted precisely at a predetermined temperature. To exactly monitor the temperature of the laser device 1, the thermistor 3 is disposed at a thermally close position to the laser device 1. The resistance value of the thermistor 3 varies depending on the temperature, therefore, the resistance value is transmitted to an automatic temperature control circuit (ATC) (a control unit) 9 as a control signal.

The automatic temperature control circuit 9 converts the signal into a drive current of the Peltier device. Then the signal flows into the Peltier device 7 to cool or heat the ceramic 6A. The heat flow is transmitted to the laser device 1 or the thermistor 3 through the heater 5 and the ceramic 6B. Such feedback circuit can stabilize the temperature around the laser device 1 to a predetermined value.

Here is a case where a temperature outside the package 8 drops. An outside temperature sensor (an outside temperature detector) 10, which is provided outside of the package 8, including a function for monitoring an outside air temperature outputs a current corresponding to the temperature. Then the ceramic substrate 6B is warmed up, and the laser device 1 and the thermistor 3 are heated. The automatic temperature control circuit 9 adjusts a current so as to decrease the heating amount of the Peltier device 7 based on an output from the thermistor 3. Specifically, a total heating amount of the heater 5 and the Peltier device 7 is transmitted to the laser device 1 and the thermistor 3.

On the contrary, to cool around the laser device 1, in a case that a temperature outside the package 8 rises or the like, a current is flowed through the Peltier device 7 by the automatic temperature control circuit 9 in an opposite direction to that in case of heating. Hence, the Peltier device 7 cools around the laser device 1 and the carrier 6 for temperature control.

Referring next to FIG. 4, description will be made on a manufacturing method for the optical transmission module according to the exemplary embodiment.

First, an alloy resistive element including platinum is vapor-deposited on the ceramic substrate 6A, and an electrode is formed thereon to construct the heater 5. The heater 5 is patterned so that heat is distributed uniformly over the whole surface of the ceramic substrate 6A. Then the ceramic substrate 6B is stacked to form the multilayer carrier 6. The ceramic substrates 6A and 6B may be made of aluminum nitride or silicon.

Then the laser device 1 and the thermistor 3 are mounted on the carrier 6, using eutectic solder such as AuSn. The thermistor 3 is disposed at a thermally close position to the laser device 1. Next, the monitor PD2 is mounted at a position where backward laser beam of the laser device 1 is irradiated. The lens 4 is mounted at a central position where forward laser beam of the laser device 1 is irradiated. The carrier 6 including such components thereon is mounted on the preliminarily soldered Peltier device 7. Finally, the Peltier device 7 provided with the carrier 6 is mounted on the package 8 to obtain the optical transmission module.

In the exemplary embodiment, a process of forming the heater 5 as an inner layer of the carrier 6 is employed and therefore passing current therethrough makes the heater 5 a heating element. Accordingly, there are advantages such as reduction in the calorific value of the Peltier device 7 and reduction in distortion by restraining a temperature difference between top and bottom faces of the Peltier device 7.

As described above, in the first exemplary embodiment, the heater 5 is built in the carrier 6 and is integrated with the Peltier device 7 for temperature control of the laser device 1. Thus, the exemplary embodiment can restrain deformation due to heating of the Peltier device 7 and maintain stable optical performance with small fluctuations in light output due to a change in outside air temperature.

More specifically, a part of heat to be produced by the Peltier device 7 is heated by the heater 5, accordingly, a temperature difference to be created by the Peltier device 7 can be reduced. Thus, the distortion amount of the Peltier device 7 itself, which is caused by the temperature difference created by the Peltier device 7, can be reduced and therefore forward laser beam irradiated from the laser device 1 can be stabilized. Accordingly, the present invention provides an optical transmission module capable of reducing a deviation between forward light output and backward light output due to a temperature change, that is, a tracking error.

The optical transmission module according to the exemplary embodiment, being structured so that the heater 5 is built inside the carrier 6, can attain higher flexibility of mounting components such as the laser device 1 on a carrier surface than that being structured so that a heater is mounted on a carrier surface. Also, with the structure according to the exemplary embodiment, the carrier 6 is more unlikely to be deformed by a temperature difference between top and bottom faces of the carrier 6.

Further, the optical transmission module according to the exemplary embodiment, including an outside temperature sensor 10 for detecting outside temperature and also including the thermistor 3 as a light-emitting device temperature detector, can perform temperature control at a higher speed and with higher precision.

In addition, the optical transmission system including the optical transmission module according to the exemplary embodiment performs temperature control based on a temperature detection result by the outside temperature sensor 10 and the thermistor 3, and therefore the temperature around the laser device 1 can be stabilized to a specific setting value, as described above, thus attaining stable optical performance by the optical transmission module described above.

### Second Exemplary Embodiment

Next, a second exemplary embodiment of the present invention will be described below.

In the second exemplary embodiment, the heater 5 in the first exemplary embodiment described above is disposed only at a portion in the vicinity of a laser device requiring heating, and a temperature sensor (a light-emitting device temperature detector) 13, instead of the thermistor 3, is provided inside the carrier 6.

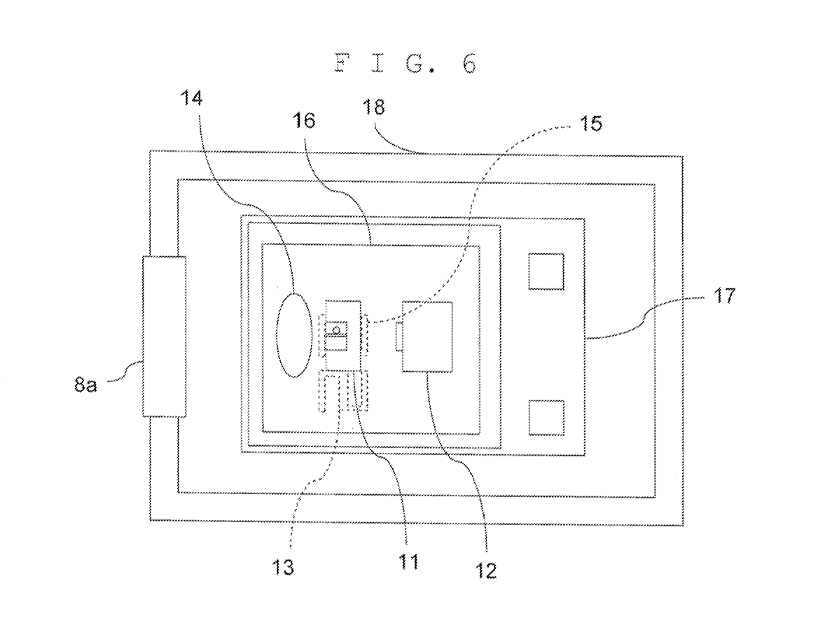

In the second exemplary embodiment, as illustrated in FIG. 6, the heater 15 is disposed only beneath the laser device 11 to narrow down a heated area, thereby exhibiting an advantage of low power consumption for heating.

In addition, by forming a temperature sensor 13 made of alloy including platinum, resistance value of which linearly changes with temperature, on an inner layer of the carrier 16 in the same way as for the heater 15, the thermistor 3 can be eliminated. Formation of the temperature sensor 13 on a ceramic substrate in the same pattern as the heater 15 enables cost reduction.

The thermistor 3 described in the first exemplary embodiment may be used instead of the temperature sensor 13 in the second exemplary embodiment.

As described above, according to the second exemplary embodiment, the heater 5 is wired only in an area in the vicinity of the laser device 11 requiring heating and such heater 5 performs heating, thus attaining efficient heating. Hence, the exemplary embodiment provides an optical transmission module including the Pertier device 7, capable of attaining the same advantage as the first exemplary embodiment above and besides attaining the low total power consumption.

As described above, the exemplary embodiment enables to reduce power consumption of the optical module and to ensure stable optical performance with small fluctuations in light outputs due to outside air temperature changes.

### Third Exemplary Embodiment

Next, a third exemplary embodiment of the present invention will be described below.

In the third exemplary embodiment, materials having different thermal resistances are used for the substrates 6A and 6B in the second exemplary embodiment above.

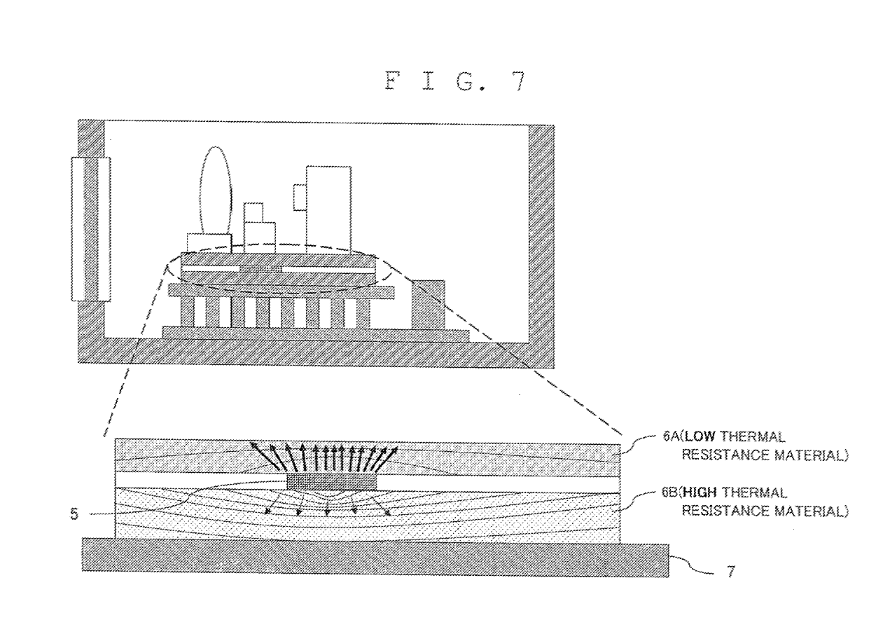

In the third exemplary embodiment, as illustrated in FIG. 7, a low thermal resistance material is used for the substrate 6A and a high thermal resistance material is used for the substrate 6B. Accordingly, the heat from the heater 5 is efficiently transferred to components including the laser device 1 while the heat from the heater 5 is not easily transferred to the Peltier device 7.

As described above, by increasing a temperature difference between top and bottom faces of the carrier 6, which is a multilayer substrate, a temperature difference between the top and bottom faces of the Peltier device 7 can de decreased by an amount corresponding to the temperature difference between top and bottom faces of the carrier 6. Accordingly, the exemplary embodiment provides the same advantages as the second exemplary embodiment above, and besides, it can further restrain generation of distortion caused by a temperature difference between the top and bottom faces of the Peltier device 7 and can further stabilize the optical performance as the optical transmission module.

In the third exemplary embodiment described above, the substrate is not limited to comprise two layers as long as the substrate comprises a structure constructed of a plurality of layers, regardless of the number of layers. In this case, the substrate on a side of the heater 5, which is closer to the laser device 1, is made of a low thermal resistance material and the other substrate, that is, on the other side of the heater 5, which is closer to the Peltier device 7 is made of a high thermal resistance material.

### Fourth Exemplary Embodiment

Next, a fourth exemplary embodiment of the present invention will be described below.

The fourth exemplary embodiment provides a structure which is configured by partially adding the high thermal resistance material to the structure of the second exemplary embodiment above.

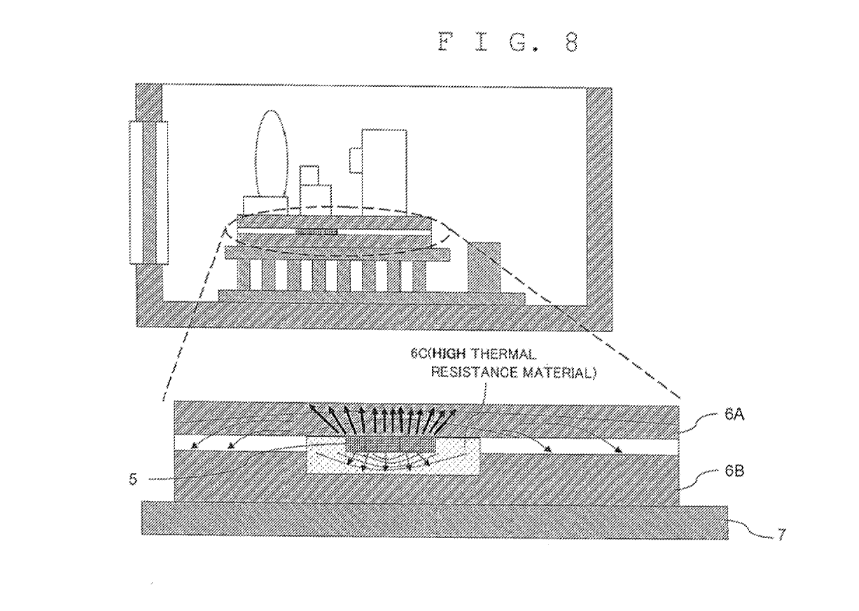

In the fourth exemplary embodiment, high thermal resistance material 6C is partially provided on a side of the heater 5, which is closer to the Peltier device 7, as illustrated in FIG. 8. The heater 5 and the high thermal resistance material 6C are disposed to be sandwiched between the substrates 6A and 6B.

By providing the high thermal resistance material 6C on a side of the heater 5, which is closer to the Peltier device 7 within the carrier 6, the heat from the heater 5 is not easily transferred to the Peltier device 7 side rather than the laser device 1 side. By increasing a temperature difference between top and bottom faces of the carrier 6, which is a multilayer substrate, a temperature difference between top and bottom faces of the Peltier device 7 can be decreased by an amount corresponding to the temperature difference between top and bottom faces of the carrier 6.

With the structure in the fourth exemplary embodiment, the heat from the heater 5 is transferred to the Peltier device 7 swerving around the high thermal resistance material 6C. Accordingly, comparing to the third exemplary embodiment above, the exemplary embodiment provides less effect of increasing a temperature difference between top and bottom faces of the carrier 6, but a substrate distortion amount can be decreased more than the structure of the third exemplary embodiment.

Accordingly, the exemplary embodiment provides the same advantages as the second exemplary embodiment above, and besides, it can further restrain generation of distortion caused by a temperature difference between top and bottom faces of the Peltier device 7, and can further stabilize the optical performance as the optical transmission module.

### Fifth Exemplary Embodiment

Next, a fifth exemplary embodiment of the present invention will be described below.

In the fifth exemplary embodiment, a low thermal resistance material is employed only to a portion between the heater 5 and the laser device 1 and a high thermal resistance material is applied to other portions, as a material of the substrates 6A and 6B in the second exemplary embodiment above.

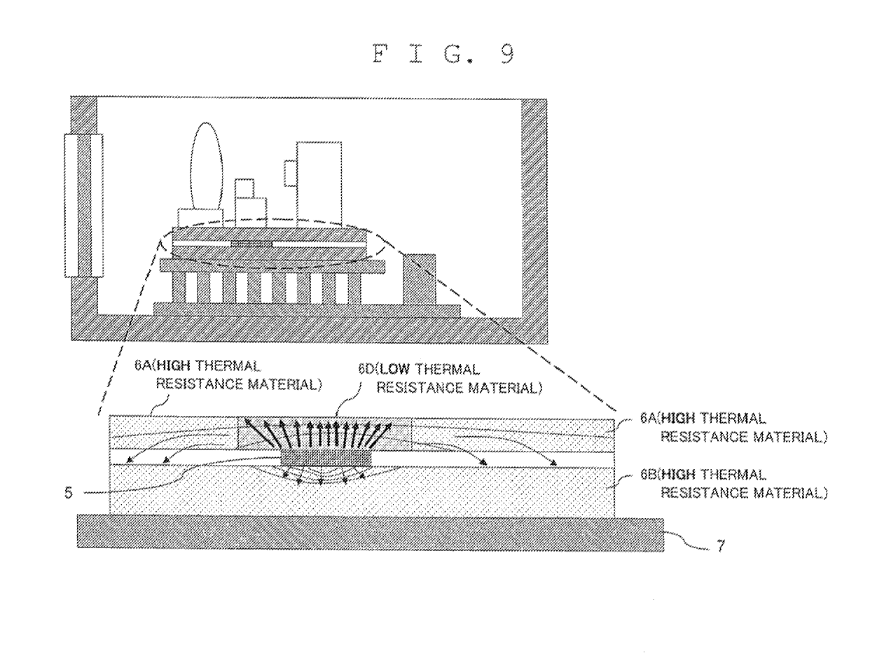

In the fifth exemplary embodiment, as illustrated in FIG. 9, a low thermal resistance material 6D is provided for a portion between the heater 5 and the laser device 1 within the substrate 6A. Other portions of the substrate 6A as a plate-shaped member for mounting components such as the laser device 1 are made of a high thermal resistance material. A substrate 6B provided on the Peltier device 7 side is also made of a high thermal resistance material.

As described above, in the exemplary embodiment, a low thermal resistance material is applied only to a portion between the heater 5 and the laser device 1 and a high thermal resistance material is applied to other portions. Accordingly, the heat from the heater 5 is efficiently transferred to the laser device 1 while the heat from the heater 5 is not easily transferred to the Peltier device 7.

As described above, by increasing a temperature difference between top and bottom faces of the carrier 6, which is a multilayer substrate, a temperature difference between the top and bottom faces of the Peltier device 7 can de decreased by an amount corresponding to the increased temperature difference between top and bottom faces of the carrier 6. Accordingly, the exemplary embodiment provides the same advantages as the second exemplary embodiment above, and besides, it can further restrain generation of distortion caused by a temperature difference between top and bottom faces of the Peltier device 7 to increase a distortion amount reduction effect of the carrier 6, and can further stabilize the optical performance as the optical transmission module.

In the fifth exemplary embodiment described above, the substrate is not limited to comprise two layers as long as the substrate comprises a structure constructed of a plurality of layers, regardless of the number of layers. In this case, the substrate on a side of the heater 5, which is closer to the laser device 1, a low thermal resistance material 6D is provided at a portion in the vicinity of the laser device 1 and other portions are made of a high thermal resistance material. The other substrate, that is, the substrate on the other side of the heater 5, which is closer to the Peltier device 7, is made of a high thermal resistance material.

### Other Exemplary Embodiments

The temperature sensor 13 described in the second exemplary embodiment may be used as an alternative to the thermistor 3 in each exemplary embodiment. Even in the case of a structure using the thermistor 3 as the light-emitting device temperature detector, the present invention may be applied to any case in the same way.

In each exemplary embodiment described above, the substrate is not limited to comprise two layers as long as the substrate comprises a structure constructed of a plurality of layers, regardless of the number of layers. In this case, the heater is sandwiched between any substrates constructing the carrier.

As described above, according to the present invention, by mounting a plurality of components including a light-emitting device on a holding unit, each component can be stably held. At the same time, generation of distortion caused by a temperature difference between top and bottom faces of a temperature adjusting unit which controls temperatures of the light-emitting device and the holding unit can be restrained to maintain stable optical performance.

The industrial applicability of the present invention will be described below. The present invention, capable of stabilizing optical performance against temperature changes, is suitably applied to an optical transmission system having a wide environmental operation temperature range, such as a wavelength division transmission system.

The foregoing descriptions are preferred exemplary embodiments of the invention, the invention is not limited thereto, and various changes and modifications may be made without departing from the spirit and scope of the invention.

What is claimed is:

1. An optical transmission module including:
a holding unit, on which a plurality of components including at least a light-emitting device are mounted;
a temperature adjusting unit that performs temperature adjustment of at least the holding unit and the light-emitting device; and
a heating unit provided inside the holding unit.

2. The optical transmission module according to claim 1, wherein the heating unit is mounted in the vicinity of the light-emitting device within the holding unit.

3. The optical transmission module according to claim 1, wherein
the holding unit includes at least two plate-shaped members; and
the heating unit is sandwiched between the plate-shaped members.

4. The optical transmission module according to claim 3, wherein, the plate-shaped member on a side of the heating unit, which is closer to the light-emitting device, is made of a low thermal resistance material and the other plate-shaped member is made of a high thermal resistance material.

5. The optical transmission module according to claim 3, wherein a high thermal resistance material is provided on a side of the heating unit, which is closer to the temperature adjusting unit within the holding unit.

6. The optical transmission module according to claim 3, wherein the holding unit includes a low thermal resistance material in the vicinity of the heating unit in the plate-shaped member on a side of the heating unit, which is closer to the light-emitting device, and other portions of the plate-shaped member and the other plate-shaped member are made of a high thermal resistance material.

7. The optical transmission module according to claim 1, wherein the holding unit and the temperature adjusting unit are mounted in a package and the holding unit is fixed on the temperature adjusting unit so as to contact the package through the temperature adjusting unit.

8. The optical transmission module according to claim 1, wherein the plurality of components mounted on the holding unit includes a light-emitting device temperature detection unit which detects a temperature in the vicinity of the light-emitting device.

9. The optical transmission module according to claim 1, wherein the light-emitting device temperature detection unit which detects a temperature in the vicinity of the light-emitting device is mounted inside the holding unit.

10. The optical transmission module according to claim 1, wherein the plurality of components mounted on the holding unit includes an optical component which condenses the light from the light-emitting device.

11. An optical transmission module including:
holding means, on which a plurality of components including at least a light-emitting device are mounted;
temperature adjusting means for performing temperature adjustment of at least the holding means and the light-emitting device; and
heating means provided inside the holding means.

12. An optical transmission system comprising the optical transmission module according to claim 1.

13. An optical transmission system, comprising:
the optical transmission module according to claim 7; and
an outside temperature detection unit which detects a temperature outside the package, wherein
the heating unit performs temperature control based on a detection result by the outside temperature detection unit.

14. An optical transmission system, comprising:
the light transmission module according to claim 8;
and a control unit which performs temperature control based on a detection result by the light-emitting device temperature detection unit.
